(19) United States
(12) Patent Application Publication
(10) Pub. No.: US 2023/0400312 A1
(43) Pub. Date: Dec. 14, 2023

(54) METHOD, APPARATUS, AND SYSTEM FOR MACHINE LEARNING OF VEHICULAR WAIT EVENTS USING MAP DATA AND SENSOR DATA

(71) Applicant: HERE Global B.V., Eindhoven (NL)

(72) Inventors: Jerome BEAUREPAIRE, Nantes (FR); Nicolas NEUBAUER, Berlin (DE)

(21) Appl. No.: 17/840,117

(22) Filed: Jun. 14, 2022

(51) Int. Cl. G01C 21/34; G06N 20/00; G06Q 50/30

(52) U.S. Cl. CPC G01C 21/3438; G06N 20/00; G06Q 50/30

(57) ABSTRACT

An approach is provided for machine learning of vehicular wait events. The approach, for instance, involves processing a sensor observation to determine a wait event. The wait event indicates that at least one person is in a wait state. The approach also involves processing the sensor observation to determine one or more contextual features associated with a location of the wait event, a time of the wait event, the at least one person, or a combination thereof. The approach further involves determining a ground truth of the wait state. The approach further involves vectorizing the one or more contextual features and the ground truth into a training vector. The approach further involves using the training vector to train a machine learning model to determine predicted waiting data based on one or more input vectors. The approach further involves providing the trained machine learning model as an output.

### BACKGROUND

Mapping service providers are continually challenged to provide compelling navigation and other location-based services. Areas of development for mapping and navigation services providers include estimating vehicular waiting time in slow traffic, predicting waiting passenger counts for bus dispatching, detecting people inside vehicle to avoid dangerous situations, such as a child left alone in a car, etc. However, there is no solution to detect the locations/links where people are waiting inside their vehicles so as to map, optimize, and improve safety, comfort, efficiency and life quality of these waiting people and other users of the road network.

### Some Example Embodiments

Therefore, there is a need for an approach for building a machine learning model to map and predict vehicular wait events.

A vehicular wait event refers to one or more people waiting inside a mode of transport that does not operate on a public schedule. Such mode of transport can be a car, bus, truck, bicycle, motorcycle, shuttle, van, taxi, shared vehicle, train, subway, boat, airplane, etc.

According to one embodiment, a method comprises processing a sensor observation to determine a wait event. The wait event indicates that at least one person is in a wait state. The method also comprises processing the sensor observation to determine one or more contextual features associated with a location of the wait event, a time of the wait event, the at least one person, or a combination thereof. The method further comprises determining a ground truth of the wait state. The method further comprises vectorizing the one or more contextual features and the ground truth into a training vector. The method further comprises using the training vector to train a machine learning model to determine predicted waiting data based on one or more input vectors. The method further comprises providing the trained machine learning model as an output.

According to another embodiment, an apparatus comprises at least one processor, and at least one memory including computer program code for one or more computer programs, the at least one memory and the computer program code configured to, with the at least one processor, cause, at least in part, the apparatus to process a sensor observation to determine a wait event. The wait event indicates that at least one person is in a wait state. The apparatus is also caused to process the sensor observation to determine one or more contextual features associated with a location of the wait event, a time of the wait event, the at least one person, or a combination thereof. The apparatus is further caused to determine a ground truth of the wait state. The apparatus is further caused to vectorize the one or more contextual features and the ground truth into a training vector. The apparatus is further caused to use the training vector to train a machine learning model to determine predicted waiting data based on one or more input vectors. The apparatus is further caused to provide the trained machine learning model as an output.

According to another embodiment, a computer program product may be provided. For example, a computer program product comprising instructions which, when the program is executed by a computer, cause the computer to process a sensor observation to determine a wait event. The wait event indicates that at least one person is in a wait state. The computer is also caused to process the sensor observation to determine one or more contextual features associated with a location of the wait event, a time of the wait event, the at least one person, or a combination thereof. The computer is further caused to determine a ground truth of the wait state. The computer is further caused to vectorize the one or more contextual features and the ground truth into a training vector. The computer is further caused to use the training vector to train a machine learning model to determine predicted waiting data based on one or more input vectors. The computer is further caused to provide the trained machine learning model as an output.

According to another embodiment, a non-transitory computer-readable storage medium carries one or more sequences of one or more instructions which, when executed by one or more processors, cause, at least in part, an apparatus to process a sensor observation to determine a wait event. The wait event indicates that at least one person is in a wait state. The apparatus is also caused to process the sensor observation to determine one or more contextual features associated with a location of the wait event, a time of the wait event, the at least one person, or a combination thereof. The apparatus is further caused to determine a ground truth of the wait state. The apparatus is further caused to vectorize the one or more contextual features and the ground truth into a training vector. The apparatus is further caused to use the training vector to train a machine learning model to determine predicted waiting data based on one or more input vectors. The apparatus is further caused to provide the trained machine learning model as an output.

According to another embodiment, an apparatus comprises means for processing a sensor observation to determine a wait event. The wait event indicates that at least one person is in a wait state. The apparatus also comprises means for processing the sensor observation to determine one or more contextual features associated with a location of the wait event, a time of the wait event, the at least one person, or a combination thereof. The apparatus further comprises means for determining a ground truth of the wait state. The apparatus further comprises means for vectorizing the one or more contextual features and the ground truth into a training vector. The apparatus further comprises means for using the training vector to train a machine learning model to determine predicted waiting data based on one or more input vectors. The apparatus further comprises means for providing the trained machine learning model as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of building a machine learning model to map and predict vehicular wait events, according to example embodiment(s);

FIGS. 2A-2B are diagrams of an example architecture for building a machine learning model to map and predict vehicular wait events, according to example embodiment(s);

FIG. 3 is a diagram of the components of a mapping platform, according to example embodiment(s);

FIG. 4 is a flowchart of a process for building a machine learning model to map and predict vehicular wait events, according to example embodiment(s);

FIGS. 5A-5B are diagrams of example user interfaces based on vehicular wait events predicted by machine learning, according to example embodiment(s);

FIG. 6 is a diagram of a geographic database, according to example embodiment(s);

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for building a machine learning model to map and predict vehicular wait events using map data and/or vehicle sensor data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

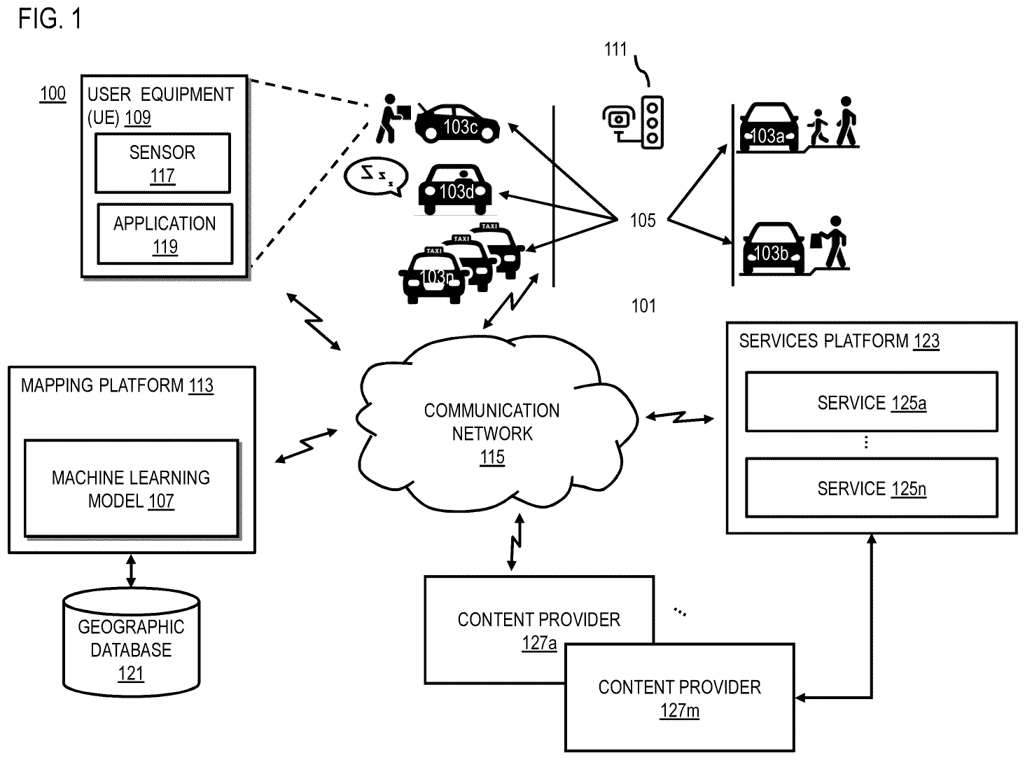

FIG. 1 is a diagram of a system 100 capable of building a machine learning model to map and predict vehicular wait events, according to example embodiment(s). Having knowledge of whether vehicular wait events are present or absent on a map link can provide important situational awareness and improved safety and convenience to vehicle users, particularly autonomous vehicles that operate with reduced or no human driver input. In addition, an understanding of where and when other vehicles may potentially be waiting is helpful for a vehicle to safely plan a route. For example, as shown in FIG. 1, a map link 101 (e.g., a road) may support bi-directional traffic with vehicles 103 waiting/parking on both directions. In FIG. 1, a vehicle 103a is waiting to pick up a school child, a vehicle 103b is waiting to pick up takeout food, a vehicle 103c is waiting to pick up groceries, a vehicle 103d has a driver resting/sleeping therein, taxis 103e-103n are waiting a pickup line, etc. (collectively referred to as vehicular wait events 105). Other vehicular wait events 105 may include picking up kids/friends at sport activities (e.g., soccer practices, baseball games, etc.), waiting for a shop to open, waiting for a special sale to start, etc. The presence of the vehicular wait events 105 can be mapped and/or precited to improve safety, reducing traffic impact, delivery of goods, services and/or media content etc.

Because of the diversity of vehicular wait events 105 and the variability of their presence along roadways, vehicular wait events 105 might be indirectly mapped via crowd-souring. For instance, users of crowdsourced traffic applications report traffic jams (moderate, heavy, standstill), police presence, etc. that might involve vehicular wait events 105. On the other hand, data collection vehicles to travel the roads do not annotate vehicular wait events. Therefore, real-time or near real-time detecting and mapping vehicular wait events 105 presents a significant technical problem. Moreover, the technical challenges also include enabling prediction of vehicular wait events 105.

To address these problem, a system 100 of FIG. 1 introduces a capability to use machine learning (e.g., a supervised learning algorithm, such as decision trees) to process sensor data and/or map information to determine the probability of a vehicular wait event 105 existing on a map link. In one embodiment, the system 100 can build a machine learning model 107 (e.g., Decision Tree, Random Forest, Neural Net, or equivalent) to predict vehicular wait events 105 on a map link of interest based on map data associated with the segment of interest, sensor data collected from one or more vehicles 103 (e.g., equipped with an array of sensors), one or more user equipment (UE) 109 (e.g., a mobile device, an embedded navigation system, a client terminal, etc., collectively referenced to herein as UEs 109), one or more infrastructure elements 111 (e.g., traffic lights, traffic cameras, traffic signals, digital signage, etc., collectively referenced to herein as infrastructure elements 111), etc.

Some UEs 109 may be carried by vehicles 103 and/or users (e.g., a driver, passenger, pedestrian, etc.) in a given area, such that the probe data and/or sensor data associated with the UEs 109 and/or vehicles 103 can be transmitted to a mapping platform 113 via a communication network 115. In one instance, the real-time probe data may be reported as probe points, which are individual data records collected at a point in time that records telemetry data for that point in time. A probe point can include attributes such as: (1) probe ID, (2) longitude, (3) latitude, (4) altitude, (5) heading, (6) speed, and (7) time. As another instance, a 3D camera can be used to detect and identify objects (e.g., drivers/passengers, vehicles, pedestrians, bicycles, traffic signs and signals, road markings, etc.), to determine vehicular wait events 105, etc.

In one instance, the UEs 109 may include one or more sensors 117 and one or more applications 119 (also collectively referred to herein as applications 111, e.g., a navigation or mapping application). In one embodiment, the sensor data collected may be stored a geographic database 121. The application 119 may be any type of application that is executable on UE 109, such as mapping applications, location-based service applications, navigation applications, content provisioning services, camera/imaging applications, media player applications, social networking applications, calendar applications, and the like.

In one embodiment, the system 100 can integrate certain Internet of things (IoT) connected to the communication network 115 using various information and communication technologies. The IoT can be embedded with various physical devices/sensors for connecting and exchanging sensor data with other devices/sensors and systems in the network, in order to detect and report vehicular wait events 105. For instance, the IoT can include the infrastructure elements 111 (e.g., a fixture or structure on the road or within the road reserve intended to provide information, shelter, or safety to a road user, such as a traffic light, sign post, traffic sign, guardrail, fence, marker post, light pole, reflector or center-line pad, divider, fence, etc.), fire hydrants, mail collection box, etc. The system 100 can map-match observed vehicular wait events 105 to corresponding locations based on map data.

In one embodiment, the system 100 may also collect real-time sensor data, and/or contextual information from one or more other sources such as government/municipality agencies, local or community agencies (e.g., a police department), and/or third-party official/semi-official sources (e.g., a services platform 123, one or more services 125a-125n (collectively referred to as services 125), one or more content providers 127a-127m (collectively referred to as content providers 127), etc.

In one embodiment, the content providers 127, services 125, and/or services platform 123 receive the vehicular wait event data and/or map data layers generated by the mapping platform 113 for executing its functions and/or services.

In another embodiment, the sensor information can be supplemented with additional information from network-based services such as those provided by the services platform 123 and the services 125. By way of example, the services 125 can include mapping service, navigation services, and/or other data services that provide data for evaluating, reporting, and handling an autonomous vehicle involving an accident and/or malfunction. In one embodiment, the services platform 123 and/or the services 125 can provide contextual information such as weather, traffic, etc. as well as facilitate communications (e.g., via social networking services, messaging services, crowdsourcing services, etc.) among vehicles to share configuration information. In one embodiment, the services platform 123 and/or the services 125 interact with content providers 127 who provide content data (e.g., map data, imaging data, etc.) to the services platform 123 and/or the services 125. In one embodiment, the UE 109 executes an application 119 that acts as client to the mapping platform 113, the services platform 123, the services 125, and/or the content providers 127. In one embodiment, the sensor data, contextual information, and/or machine learning data can be stored in a database (e.g., the geographic database 121) for use by the mapping platform 113. All information shared by the system 100 should be filtered via privacy policy and rules set by the system 100 and/or data owners, such as removing personal information before sharing with third parties.

With the machine learning model 107, the system 100 can identify such locations/areas where people are waiting inside their vehicles, thereby increasing safety for people waiting alone in the vehicles (e.g., to avoid carjacking or thieves), providing marketing metric related to how much time people wait in vehicles (for any given person, vehicle or aggregated) for promoting infotainment systems, delivering products/services (e.g., coffee, food, talking to other people, etc.) to people waiting at certain location(s), providing efficiency/optimization with better waiting option(s) (e.g., organizing a pickup carpooling), etc.

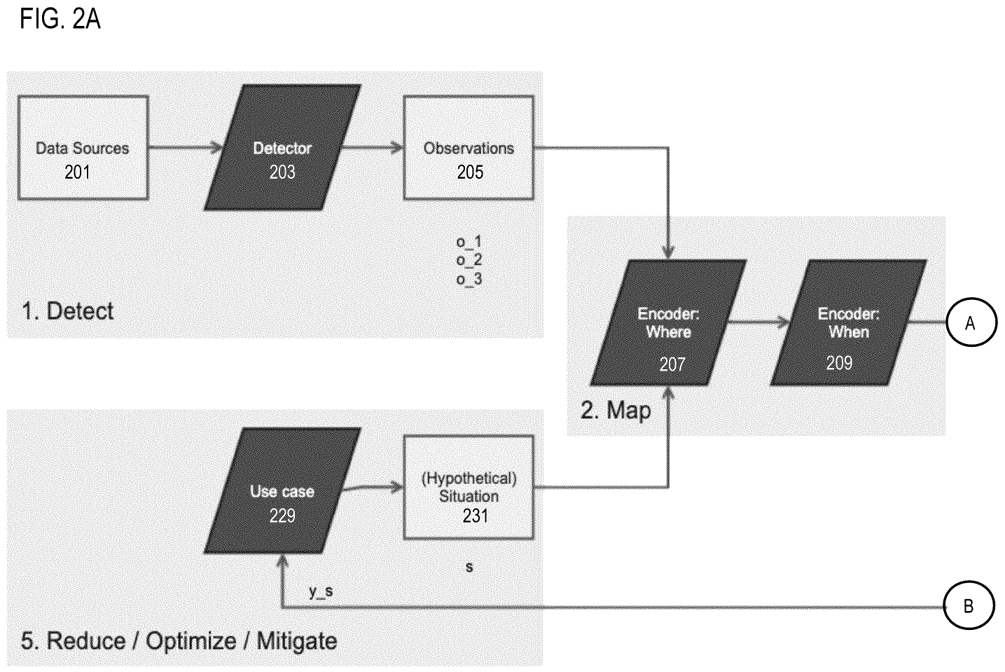

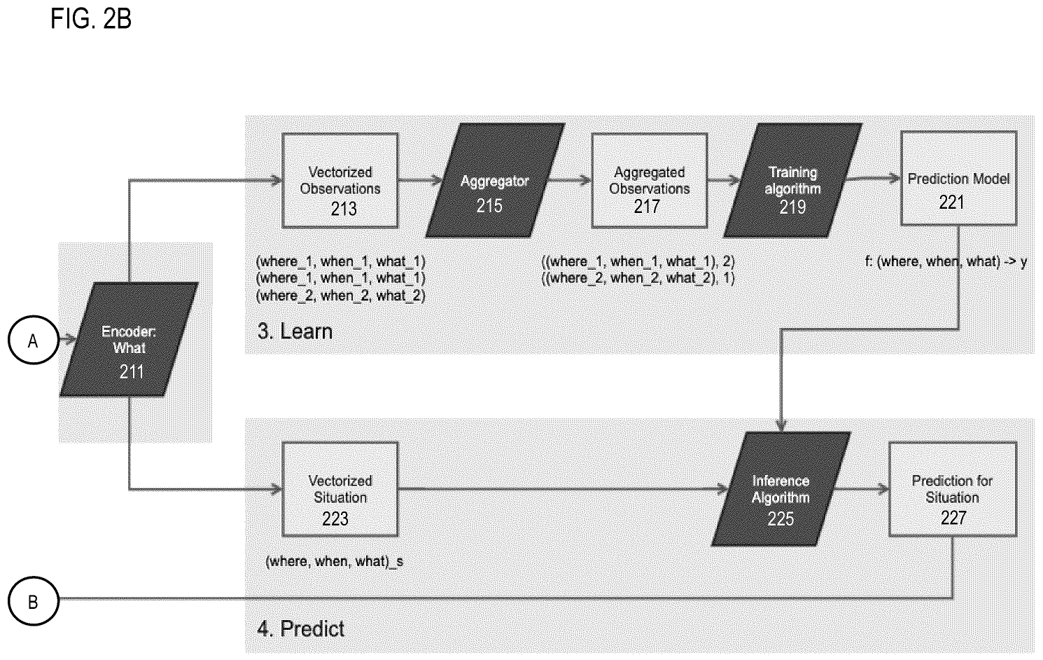

FIGS. 2A-2B are diagrams of an example architecture for building a machine learning model to map and predict vehicular wait events, according to example embodiment(s). During a Detect stage, the system 100 can detecting people are waiting inside their parked vehicles via creating a set of observations 205 (e.g., o_1, o_2, o_3) of vehicular wait events 105 from one or more input data sources 201 using detector(s) 203. For instance, the data sources 201 can include probe data, sensor data, etc. collected via the detector(s) 203, such as the vehicles 103, the UEs 109 and/or the infrastructure elements 111. The probe data can include probe data of the vehicles 103 (including parked vehicles, passing-by vehicles, etc.) and/or probe data of the UEs 109 (including stand-alone UEs, UEs in parked vehicles, UEs in passing-by vehicles, etc.). The sensor data can include sensor data of the vehicles 103, sensor data the UEs 109, and/or sensor data the infrastructure elements 111 (e.g., traffic/safety cameras), etc.

Besides location data of the vehicular wait events 105, the system 100 can extract from the sensor data a start/end time of the wait event, a duration/length of the event, a number of vehicles involved (e.g., waiting on the same link), weather conditions, etc.

During a Map stage, the system 100 can map the vehicular wait events 105 via transforming the observations 205 (e.g., o_1, o_2, o_3) of the vehicular wait events 105 into machine-readable and generalizable vectors, for example, using a Where encoder 207 to encode location, a When encoder 209 to encode time and temporal phenomena, and a What encoder 211 to encode the observations 205. The timestamp of an observation can be less expressive than translated into temporal phenomena, e.g., “autumn,” “Saturday night,” etc. The Map stage can create enough contextual data around the observations 205 of the vehicular wait events 105 (e.g., a location of the wait event, a time of the wait event, at least one waiting person, attributes of the map link, etc.), such that the system 100 can detect commonalities of the vehicular wait events 105 by one or more algorithms later. After detecting the vehicular wait events 105, the system 100 can mark them on a map (e.g., at the link level, considering the offset on the links), together with their characteristics. In another embodiment, the system 100 can aggregate the vehicular wait events 105 into a spatial entity, such as a vector format suitable to be used as a feature vector for machine learning.

During a Learn stage, to generate a training dataset that will provide desired output values, i.e., to train a model on the resulting (observation, output) pairs, the system 100 can detect the number of events to be expected while traversing a link. For instance, the system 100 can translate each of the observations 205 (e.g., o_1, o_2, o_3) into vectorized observations 213, i.e., in a vector format suitable to be used as a feature vector for machine learning, as e.g., (where_1, when_1, what_1), (where_1, when_1, what_1), (where_2, when_2, what_2). The system 100 can apply an aggregator 217 to aggregate the vectorized observations 213 into aggregated observations 215 e.g., ((where_1, when_1, what_1), 2), ((where_2, when_2, what_2), 1), by adding a count of the same feature vector. In other words, the system 100 can aggregate all the occurrences detected on a particular link during a particular setting (i.e., all occurrences having the same vector representation, as shown in FIGS. 2A-2B, where o_1 and o_2 share the same representation and result in a single entry with a count of “2”). The system 100 can then apply a training algorithm 219 on the aggregated observations 215 to generate a vehicular wait event prediction model 221 (e.g., the machine learning model 107), e.g., f (where, when, what)->y. In many situations, additional data may be required to contrast occasions where observations occurred with a baseline of underlying events with no observations were made.

In one embodiment, to train the vehicular wait event prediction model 221, the system 100 can execute a standard classification, a regression task, or a combination thereof. The system 100 may, for example in a classification or regression task, vectorize current situation datapoints and/or sensor observations, and determine which of existing vectorized training model cases the current situation datapoints and/or sensor observations correspond to. With the inputs described above, the system 100 can learn when and where are people waiting inside their parked vehicles. The system 100 can even evaluate the main reason(s) why people waiting inside their parked vehicles, and classify the vehicular wait events 105 into various types: parents waiting for kids at school, parents waiting for kids or friends at sport activities, people waiting for a shop to open, people having to sleep inside their vehicle/truck, taxi driver waiting for the next ride in the car, a person picking up a friend, etc. The system 100 can also determine where people waiting inside their parked vehicles would happen most frequently, such as in the vicinity of specific points of interest (e.g., schools, hospitals, sport facilities, etc.), at specific links, etc.

The vehicular wait event prediction model 221 generated and trained based on the previous stages can predict the likelihood of people waiting inside their parked vehicles at specific time and map link, e.g., on link 1234 between 19:00 and 19:05. During a Predict stage, the system 100 can use the model 221 (e.g., transfer learning) to predict values for new situations (“s”) in areas where historical data unavailable. For instance, the system 100 can transform a new situation “s”, e.g., s_1) into a vectorized situation 223, i.e., in a vector format suitable to be used as a feature vector for machine learning, as e.g., (where, when, what_s), using the Where encoder 207, the When encoder 209, and the What encoder 211. The system 100 then apply an inference algorithm 225 on the vectorized situation 223 based on the vehicular wait event prediction model 221, to generate a prediction 227 for the new situation “s”, e.g., s_n. In one embodiment, the model 221 can be used as a baseline, then the system 100 can apply data collected in such area to adapt the model 221 to better match/capture the local behaviors.

During a Reduce/Mitigate/Improve stage, the system 100 can apply the vehicular wait event prediction model 221 on other use case, such as context-aware routing. For instance, the system 100 can convert a use case 229 (e.g., y_s) into a (hypothetical) situation 231 (e.g., “s”), then process the (hypothetical) situation 231 similarly via the Map stage and the Predict stage as handling the new situation “s”, e.g., s_n. For instance, the situation 231 includes e.g., creating routes at different times, represent each link and time option to be vectorized through the Map stage and the Predict stage to predict the value(s) of interest for each. The system 100 can then use the predicted value(s), e.g., by adding the predicted values to a link cost during routing, and find best/optimal routes according to new aggregate cost(s).

To make the situations safer or more convenient, the system 100 can contextually apply the predicted value(s), and (1) suggest people having similar mobility and waiting patterns to car-pool, (2) suggest to meet up some of those people who are also waiting if desired or based on matching social profiles, (3) offer people waiting coupons for local shops, (4) offer delivery of services and goods to a waiting location (e.g., parcel deliveries, food, coffee, etc.), (5) suggest activities to do in the available time (e.g., shopping, making a necessary call, watching a video, meditating, etc.), (6) suggest games to play inside the vehicle's infotainment, (7) provide vehicle original equipment manufacturers metric related to how much time people wait in vehicles (e.g., for any given person, vehicle or aggregated) in order to promote vehicle infotainment systems (e.g., the more a user is waiting in the car, the more relevant a large screen with dedicated service), etc.

In one embodiment, the system 100 can apply the vehicular wait event prediction model 221 for mapping applications, such as showing in a map areas where lots of people waiting inside their parked vehicles (e.g., at certain time of the day).

In one embodiment, the system 100 can apply the vehicular wait event prediction model 221 for routing, such as considering predicted vehicular wait event(s) as inputs for a routing algorithm: “Avoid this link at this time of the day if it is known that lots of vehicles will park and leave parking spaces.”

In one embodiment, the system 100 can apply the vehicular wait event prediction model 221 for providing services, such as recommending personalized and/or contextual services to the people waiting in the vehicles.

In one embodiment, the system 100 can apply the vehicular wait event prediction model 221 for providing warnings, such as warning people to pay special attention at some given locations and time as people waiting in vehicles that there will be a group of children leaving a building associated with vehicular wait event(s).

In one embodiment, the system 100 can apply the vehicular wait event prediction model 221 for predicting local impact(s) on traffic and parking by predicted vehicular wait event(s). For instance, the system 100 can detect all the parking patterns of people coming around the same time and waiting in their vehicles (e.g., 20 parking spots will be free within 5-min) to predict impact on traffic and parking in the area.

In one embodiment, the system 100 can apply the vehicular wait event prediction model 221 with autonomous vehicles (AVs) in knowing where and when there can more likely be people waiting inside their parked vehicles as an input for: (1) a risk calculation algorithm, (2) a routing algorithm, (3) adapting their safety distances at specific locations and time, (4) choosing a lane to travel on, (5) suggesting those people to share vehicles as an alternative to taking their own vehicles, etc.

In one embodiment, the system 100 can also integrate a confidence interval/factor to measure the accuracy of the vehicular wait events 105, e.g., using machine learning and/or other authentication methods. For instance, the confidence factor can indicate a certainty level of the output from clustering of the probes and this confidence factor can range between 0 and 1, for example. When the confidence factor is closer to one (e.g., 0.8), the system 100 is highly confident that a vehicular wait event is present at the map link. As a result, the system 100 can report the vehicular wait event. When the confidence factor is closer to 0 (e.g., 0.35), the system 100 is unlikely to infer with confidence that a vehicular wait event is present at the location point. As a result, the system 100 will not suppress/prune the vehicular wait event from reporting.

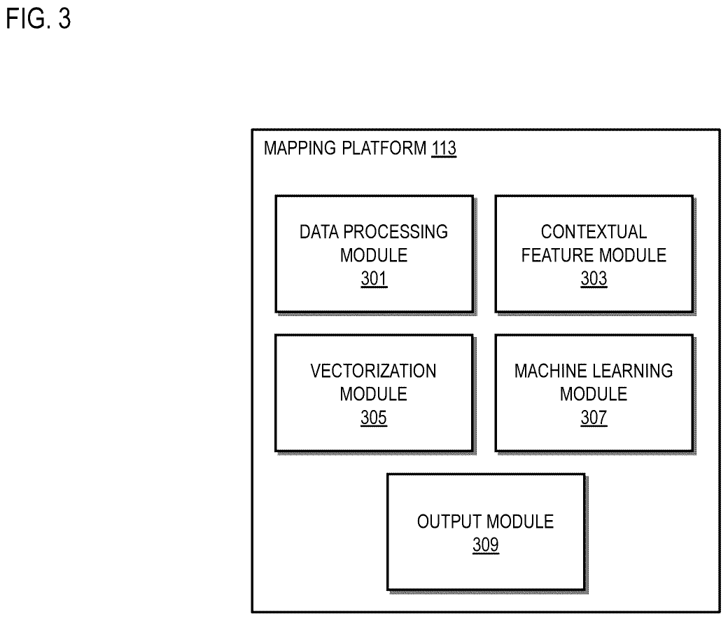

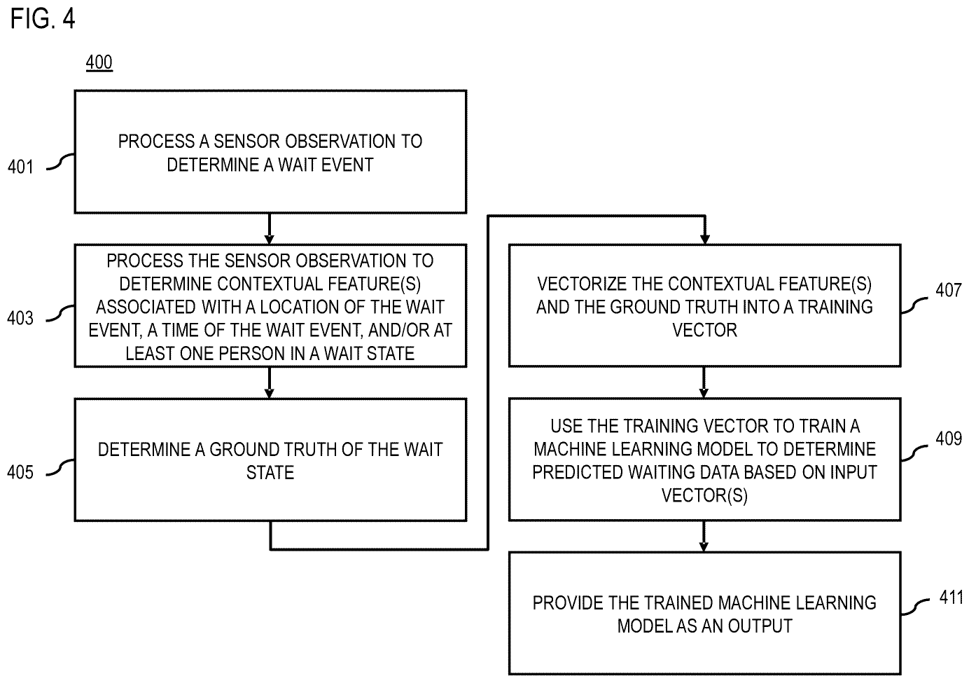

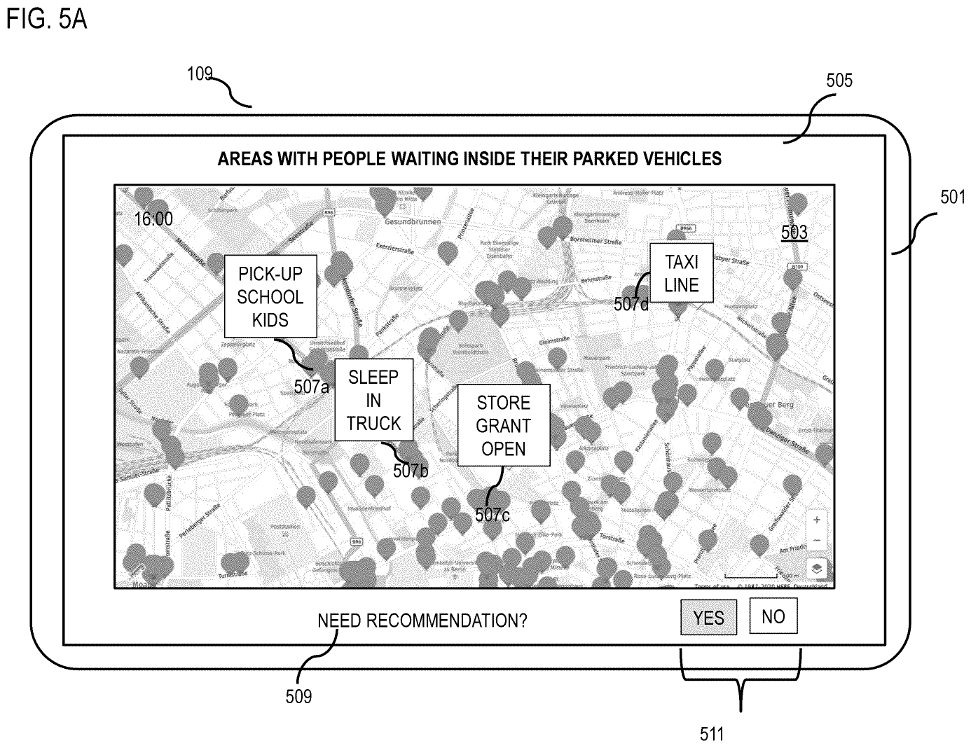

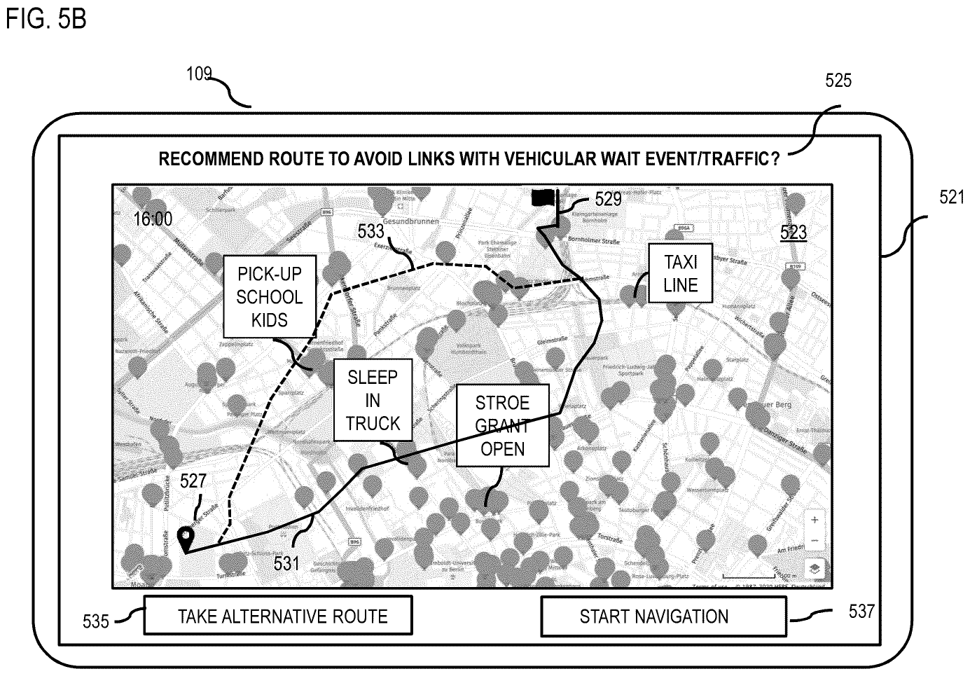

FIG. 3 is a diagram of the components of a mapping platform, according to example embodiment(s). By way of example, the mapping platform 113 includes one or more components for building a machine learning model to map and predict vehicular wait events according to the various embodiments described herein. It is contemplated that the functions of these components may be combined or performed by other components of equivalent functionality. In this embodiment, the mapping platform 113 include a data processing module 301, a contextual feature module 303, a vectorization module 305, a machine learning module 307, and an output module 309. The above presented modules and components of the mapping platform 113 can be implemented in hardware, firmware, software, or a combination thereof. Though depicted as separate entities in FIG. 1, it is contemplated that the mapping platform 113 may be implemented as a module of any of the components of the system 100 (e.g., a component of the vehicles 103, the UEs 109, the services platform 123, the services 125, etc.). In another embodiment, one or more of the modules 301-309 may be implemented as a cloud based service, local service, native application, or combination thereof. The functions of the mapping platform 113, and modules 301-309 are discussed with respect to FIGS. 4-5 below.

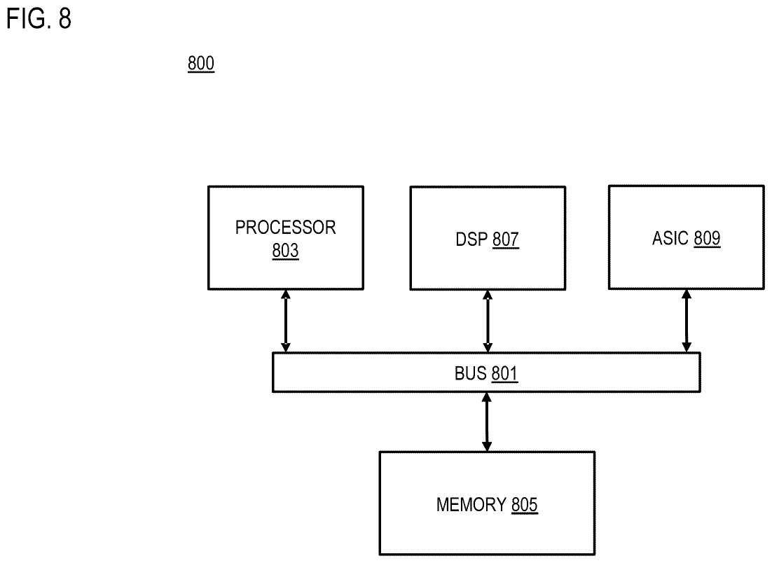

FIG. 4 is a flowchart of a process for building a machine learning model to map and predict vehicular wait events, according to example embodiment(s). In various embodiments, the mapping platform 113, and/or any of the modules 301-309 may perform one or more portions of the process 400 and may be implemented in, for instance, a chip set including a processor and a memory as shown in FIG. 8. As such, mapping platform 113, and/or any of the modules 301-309 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all of the illustrated steps. The process 400, for instance, describes the process for collecting map and/or vehicular sensor data to train a machine learning model (e.g., machine learning model 107) to predict vehicular wait events for a given map link.

In one embodiment, for example, in step 401, the data processing module 301 can process a sensor observation to determine a wait event (e.g., a vehicular wait event such as the vehicle 103a waiting to pick up a school child, the vehicle 103b waiting to pick up takeout food, the vehicle 103c waiting to pick up grocery, the vehicle 103d with a driver resting/sleeping therein, the taxis 103e-103n waiting a pickup line, etc.). The wait event can indicate that at least one person (e.g., a driver of the vehicle 103) is in a wait state. For instance, the wait state can include the at least one person waiting inside a vehicle (e.g., the vehicular wait event), and the sensor observation can comprise sensor data captured by one or more sensors of a device (e.g., the UE 109), a vehicle (e.g., the vehicle 103), an infrastructure element (e.g., the infrastructure element 111), or a combination thereof associated with or within a field of view of the at least one person. As another instance, the wait state can indicate that the at least one person is remaining within a predetermined proximity of the location of the wait event until an occurrence of an anticipated event (e.g., to pick up a school child, takeout food, grocery, taxi riders, etc.).

The data processing module 301 can detect using just the sensor observation or deduce additional contextual information to determine a wait event. For example, the sensor observation can use location sensors to pick up a vehicle waiting at a given location, use pressure sensors image sensors, and/or LiDAR sensors to detect movements in the vehicle, use motion sensors, image sensors, and/or LiDAR sensors to detect user interactions in the vehicle, stationary/moving objects outside the vehicle (i.e. picking up “what” is), etc.

To enrich the sensor observation with contextual information, the data processing module 301 can infer “why” and/or “how” of the wait event. For instance, waiting outside a school can be detected via location sensors, while the relevant contextual information (such as a time of day, day of the week, scheduled appointment (e.g., to a pediatrician), etc.) can be used to infer that this is not simple stopping and waiting instance, but actually waiting for a child to come out of the school. The data processing module 301 can consider other contextual information such as user mobility data message data, calendar data, social media data, etc.

In one embodiment, the predicted waiting data can include a predicted likelihood of at least one subsequent person (e.g., a parent) waiting at a predicted location (e.g., near a school entrance), a predicted time (e.g., 4:00 pm weekday), or a combination thereof. In another embodiment, the predicted waiting data can include a predicted reason (e.g., to pick up a school kid) for the at least one person being in the wait state, and the predicted reason can include at least one of: the at least one person waiting to pick another person (e.g., a kid, a friend, a passenger, a customer, etc.); the at least one person waiting for a point of interest (e.g., a store, a restaurant, a theme park, a bank, a post office, a theater, a concert hall, a museum, a baseball stadium, etc.) to open; or the at least one person (e.g., a truck driver) sleeping in a vehicle.

In one embodiment, in step 403, the contextual feature module 303 can process the sensor observation to determine one or more contextual features associated with a location of the wait event (e.g., a POI), a time of the wait event (e.g., a time of the day, Friday night, etc.), the at least one person (e.g., a parent, a taxi driver, etc.), or a combination thereof. As other instances, the one or more contextual features can further include one or more attributes of the map link determined from a geographic database (e.g., the geographic database 121). For example, the one or more attributes can include a functional class (e.g., an arterial, collector, or local road), a speed limit, a presence of a road sign, a bi-directionality, a number of lanes, a speed category, a distance to a point of interest, a stopping or parking sign, a designated stopping or parking area, or a combination thereof associated with the map link.

In one embodiment, the contextual feature module 303 can map-match location data of the sensor observation to a map link (e.g., a road link, a bicycle lane, a sidewalk, a waterway, an air plane runway, a roadside rest area, etc.), an offset on the map link (e.g., a distance from one end node of a map link), or a combination thereof to determine the location of the wait event.

In one embodiment, in step 405, the data processing module 301 can determine a ground truth of the wait state. The ground truth data can indicate a true presence or a true absence of the vehicular wait events 105 on the map link. The ground truth data can be collected using traditional or equivalent techniques (e.g., manual human annotation of a collected sensor data observation to indicate presence or absence of a vehicular wait event and/or its type or characteristics, active user surveying with questions on vehicle's UI, etc.). For example, a map service provider can operate a fleet of map data collection vehicles that can more sophisticated, accurate, or different types of sensors (e.g., radar, cameras, LiDAR, etc.). In one embodiment, only segments for which ground truth data is collected or otherwise available are selected for training the machine learning model.

In one embodiment, when independent ground truth data is not available or otherwise not used, the machine learning module 307 can use the underlying sensor data individually to estimate whether a vehicular wait event is present or absent on the corresponding map link. For example, image recognition can be performed on camera sensor data collected from a vehicle traveling the map link. If image recognition results in detecting the presence or absence a vehicular wait event in the image data, the results can be used as pseudo-ground truth data to train the machine learning model 107. In this way, when operating with independent ground truth data, map and sensor data collected from one map link can be used to train the machine learning model 107 to predict the presence or absence of vehicular wait events on other map links.

In one embodiment, in step 407, the vectorization module 305 can vectorize the one or more contextual features and the ground truth into a training vector (e.g., similar to transforming a situation into a vector using the Map stage and the Learn Stage of FIGS. 2A-2B).

In one embodiment, in step 409, the machine learning module 307 can use the training vector to train a machine learning model (e.g., training the machine learning model 107 in the Learning stage in FIGS. 2A-2B) to determine predicted waiting data based on one or more input vectors. As previously discussed, the machine learning model 107 can be based on any supervised learning model (e.g., Decision Tree, Random Forest, Neural Net, Deep Learning, logistic regression, etc.). For example, Decision Trees are a type of supervised machine learning where the data is continuously split according to a certain parameter. The tree includes two entities, i.e., decision nodes (e.g., where the data is split based on parameters such as nearby POI type, waiting time of the day, waiting/waited person profile/characteristic, etc.) and leaves (e.g., decisions or the final outcomes). There are two main types of Decision Trees: classification trees (discrete data types) and regression trees (continuous data types), and the final outcomes can be a type/category of vehicular wait events.

In the case of Random Forest, a random forest is a forest of randomly created decision trees (each created based on a random subset of features), thus less sensitive to the data set. Therefore, a decision tree is fast and operates easily on large data sets (yet sensitive the data set), while the random forest model needs rigorous training and less sensitive to the data set based on majority voting/averaging. For instance, the random forest can include a decision tree of (school, Wednesday afternoon, parent, etc.), a decision tree of (restaurant, Friday night, taxi driver), a decision tree of (grocery store, Wednesday afternoon, single), etc.

In the case of a neural network, the machine learning model 107 can consist of multiple layers or collections of one or more neurons (e.g., processing units of the neural network) corresponding to a feature or attribute of the input data (e.g., the feature vector generated from the map and/or sensor data as described above).

For instance, during training, the machine learning module 307 can feed feature vectors from the training data set (e.g., created from map and/or sensor data as described above) into the machine learning model 107 to compute a predicted matching feature (e.g., vehicular wait event and/or other related characteristic to be predicted) using an initial set of model parameters. For example, the target prediction for the machine learning model 107 can be whether there is a vehicular wait event present for a given map link (e.g., 5-meter road segment). In one embodiment, the machine learning model 107 can also be used to model or predict shape, distance from a road reference point to the vehicular wait event, and/or other attributes of the vehicular wait event 105 if the ground truth data contains attributes or feature labels.

The machine learning module 307 can compare the predicted matching probability and the predicted feature to the ground truth data (e.g., the manually marked feature labels) in the training data set for each sensor data observation used for training. In addition, the machine learning module 307 can compute an accuracy of the predictions for the initial set of model parameters. If the accuracy or level of performance does not meet a threshold or configured level, the machine learning module 307 can incrementally adjust the model parameters until the model generates predictions at a desired or configured level of accuracy with respect to the manually marked labels of the ground truth data. In other words, a “trained” machine learning model 107 is a model with model parameters adjusted to make accurate predictions with respect to the training data set and ground truth data.

In another embodiment, the machine learning module 307 can apply a machine learning data matrix/table on contextual features including road feature(s) (e.g., speed limit, guard rail (e.g., poles, beacon/sensor, etc.), signs, map features associated with additional roadway furniture, navigable or non-navigable, etc.); parking/stopping area feature(s) (e.g., polygon, type, restricted usage, restricted hours, etc.); mode of transport feature(s) (e.g., make, model, sensors, speed, sensor operations, autonomous vehicle (AV)/manual mode, etc.); user features (e.g., age, height, stride, mobility patterns, etc.); environmental features (e.g., weather, events, traffic, traffic light status, construction status, visibility, etc.), etc., in addition to vehicular wait event categories (e.g., parents waiting for kids at school, parents waiting for kids or friends at sport activities, people waiting for a shop to open, people having to sleep inside their vehicle/truck, taxi driver waiting for the next ride in the car, a person picking up a friend, etc.) and action categories (e.g., people with similar mobility and waiting patterns to car-pool, to meet up some of the people who are also waiting based on matching social profiles, to offer people waiting coupons for local shops, activities to do in the available time, to play games inside the vehicle's infotainment, to provide vehicle original equipment manufacturers metric related to how much time people wait in vehicles, etc. For instance, a vehicular wait event category can be derived from map data, sensor data, probe data, the above-listed contextual feature data, etc. using the vehicular wait event machine learning model to identify a vehicular wait event.

By way of example, the matrix/table can list relationships among context features and training data. For instance, notation [symbol] rdf [symbol] \hat{ }i can indicate the ith set of road features, notation [symbol] pkf [symbol] \hat{ }i can indicate the ith set of parking/stopping area features, [symbol] vf [symbol] \hat{ }i can indicate the ith set of mode of transport features, [symbol] uf [symbol] \hat{ }i can indicate the ith set of user features, [symbol] ef [symbol] \hat{ }i can indicate the ith set of environmental features, etc.

In one embodiment, the training data can include ground truth data taken from historical vehicular wait event data (e.g., stored in or accessible via the geographic database 121). For instance, in a data mining process, context features are mapped to ground truth map objects/features to form a training instance. A plurality of training instances can form the training data for the vehicular wait event machine learning model using one or more machine learning algorithms, such as decision trees, random forest, etc. For instance, the training data can be split into a training set and a test set, e.g., at a ratio of 70%:30%. After evaluating several machine learning models based on the training set and the test set, the machine learning model that produces the highest classification accuracy in training and testing can be used (e.g., by the machine learning module 307) as the vehicular wait event machine learning model. In addition, feature selection techniques, such as chi-squared statistic, information gain, gini index, etc., can be used to determine the highest ranked features from the set based on the context feature's contribution to classification effectiveness.

In other embodiments, ground truth vehicular wait event data can be more specialized than what is prescribed in the matrix/table. For instance, the ground truth could be specific vehicular wait events. In the absence of one or more sets of the contextual features, the model can still function using the available features.

In one embodiment, the vehicular wait event machine learning model can learn from one or more feedback loops based on, for example, vehicle behavior data and/or feedback data (e.g., from users), via analyzing and reflecting how vehicular wait event conflicts were generated, etc. The vehicular wait event machine learning model can learn the cause(s), for example, based on the vehicular wait event categories and/or action categories and/or actions, to identify vehicular wait events and to add new vehicular wait events/features into the model based on this learning.

In other embodiments, the machine learning module 307 can train the vehicular wait event machine learning model to select or assign respective weights, correlations, relationships, etc. among the contextual features, to identify vehicular wait events and to add new vehicular wait events/features and/or actions into the model. In one instance, the machine learning module 307 can continuously provide and/or update the machine learning models (e.g., a decision tree, support vector machine (SVM), neural network, etc.) of the machine learning module 307 during training using, for instance, supervised deep convolution networks or equivalents. In other words, the machine learning module 307 trains the machine learning models using the respective weights of the features to most efficiently select optimal action(s) to take for different vehicular wait event scenarios in different geographic areas (e.g., streets, city, country, region, etc.).

In another embodiment, the machine learning module 307 of the mapping platform 113 includes a neural network or other machine learning system(s) to update enhanced features in different geographic areas. In one embodiment, the neural network of the machine learning module 307 is a traditional convolutional neural network which consists of multiple layers of collections of one or more neurons (which are configured to process a portion of an input data). In one embodiment, the machine learning module 307 also has connectivity or access over the communication network 115 to the geographic database 121 that can each store map data, the feature data, the output data, etc.

In other embodiments, the machine learning module 307 can use the trained machine learning model to determine the predicted waiting data, and initiate at least one of: (1) generating navigation routing data, mapping data, or a combination thereof based on the predicted waiting data; (2) recommending at least one other person for meeting up, carpooling, or a combination thereof based on the predicted waiting data; (3) recommending at least one activity, at least one good, at least one service, marketing information, vehicle infotainment option, or a combination thereof based on the predicted waiting data; (4) delivering at least one good, at least one service, or a combination thereof to a location of a wait event based on the predicted waiting data; (5) presenting a warning message based on the predicted waiting data; or (6) predicting an impact on parking, traffic, or a combination thereof based on the predicted waiting data.

In yet other embodiments, the machine learning module 307 can use the trained machine learning model to determine the predicted waiting data, and use the predicted waiting data as an input to an autonomous vehicle control system for at least one of: (1) risk calculation; (2) routing; (3) adapting a safety distance at a specific location, a specific time, or a combination thereof; (4) selecting a travel lane; and (5) sharing a ride.

In one embodiment, in step 411, the output module 309 can provide the trained machine learning model as an output (e.g., for the Predict stage and the Reduce/Mitigate/Improve stage of FIGS. 2A-2B). For instance, the output module 309 can use the trained machine learning model 107 to a generate a vehicular wait event overlay (e.g., a map layer) of a map representation of a road network. The observations can then be used an input into the trained machine learning model 107 as discussed. In one embodiment, the vehicular wait event overlay indicates a presence or an absence of one or more vehicular wait events in the road network of the map representation.

In other words, in one embodiment, given the training data above, the mapping platform 113 can run a batch process (e.g., every 24 hours or any other configured time interval) and extract the feature vectors as described above, and pass the feature vectors to the already trained machine learning model 107. The trained machine learning model 107 can output whether the map link (e.g., 5-meter segment) corresponding to the input feature vector contains a vehicular wait event or not. In another embodiment, the system 100 can collect sensor observation data of a vehicle (e.g., the vehicle 103), determine one or more contextual features associated with the sensor observation data, apply a waiting state model (e.g., the machine learning model 107 trained via the process of FIGS. 2A-2B) on the one or more contextual features to determine a waiting state associated with the vehicle (e.g., at least one person waiting inside the vehicle). For instance, the one or more contextual features can be associated with a location of the waiting state (e.g., a POI), a time of the waiting state (e.g., a time of the day, Friday night, etc.), at least one person waiting inside the vehicle (e.g., a parent, a taxi driver, etc.), or a combination thereof. By way of example, the sensor observation data can comprise sensor data captured by one or more sensors of a device (e.g., the UE 109), a vehicle (e.g., the vehicle 103), an infrastructure element (e.g., the infrastructure element 111), or a combination thereof associated with or within a field of view of the at least one person.

The system 100 can then provide one or more services based on the waiting state. For instance, the one or more services can include: (1) generating navigation routing data, mapping data, or a combination thereof based on the waiting state; (2) recommending at least one other person for meeting up, carpooling, or a combination thereof based on the waiting state; (3) recommending at least one activity, at least one good, at least one service, marketing information, vehicle infotainment option, or a combination thereof based on the waiting state; (4) delivering at least one good, at least one service, or a combination thereof to a location of a wait event based on the waiting state; (5) presenting a warning message based on the waiting state; or (6) predicting an impact on parking, traffic, or a combination thereof based on the waiting state.

By way of example, FIGS. 5A-5B are diagrams of example user interfaces based on vehicular wait events predicted by machine learning, according to example embodiment(s). In one embodiment, example user interface (UI) 501 of FIG. 5A is generated for a UE 109 (e.g., a mobile device, an embedded navigation system, a client terminal, etc.) that includes a map 503 of vehicular wait events (shown as popups). The UI 501 also highlights vehicular wait event cluster areas 505a-505d, and a message 507 of “areas with people waiting inside their parked vehicles.” In this case, there are a cluster area 505a for picking up school kids, a cluster area 505b for sleeping in trucks, a cluster area 505c for a store grant opening, and a cluster area 505d for a taxi line.

In this case, the system 100 can automatically work in the background and detect the user context information, and have the UI 501 display a user prompt 509 of “Need recommendation?” In response to user selection of Yes option of the options 511, the UI 501 displays a list of recommendations (not shown) based on the user context information. For instance, the list can include parking recommendation, vehicle infotainment recommendation, service/product recommendation, activity recommendation, event recommendation, meeting recommendation, POI/destination recommendation, route recommendation, carpool recommendation, etc. The system 100 can determine the recommendations based on the location/characteristics (e.g., operational conditions, environmental conditions, etc.) of the vehicle 103/UE 109, the locations/characteristics of nearby vehicles 103/UEs 109, mobility graph of the vehicle 103/UE 109, characteristics of the map link and near-by POIs, local weather and traffic, etc. as in the above-discussed embodiments. In case that the user changes trip plan on demand, the system 100 can dynamically update the recommendations for the user.

FIG. 5B is a diagram of an example user interface for navigating around vehicular wait event cluster areas, according to one embodiment. In response to user selection of a route recommendation, a UI 821 of FIG. 5B can display a map 523 with a user prompt 525 of “Recommend route to avoid links with vehicular wait event/traffic?” In this example, the UI 821 shows a user current location 527, a user destination 529, a standard route 531, and an alternative route 533 that avoids links with vehicular wait event/traffic. In response to user selection of a “Take alternative route” option 535 and a “Start navigation” option 537, the UI 521 displays navigation directions for the alternative route.

The above-discussed embodiments can apply the vehicular wait event prediction model 221 for (1) mapping applications, such as showing in a map areas where lots of people waiting inside their parked vehicles (e.g., at certain time of the day), (2) routing, (3) providing services, such as recommending personalized and/or contextual services to the people waiting in the vehicles, (4) providing warnings, such as to pay special attention at some given locations and time as people waiting in vehicles that there will be a group of children coming, (5) predicting local impact(s) on traffic and parking by predicted vehicular wait event(s).

In one embodiment, the system 100 can apply the vehicular wait event prediction model 221 with autonomous vehicles (AVs) in knowing where and when there can more likely be people waiting inside their parked vehicles as an input for: (1) a risk calculation algorithm, (2) a routing algorithm, (3) adapting their safety distances at specific locations and time, (4) choosing a lane to travel on, (5) suggesting those people to share vehicles as an alternative to taking their own vehicles, etc.

By way of example, the UEs 109 may be a personal navigation device (“PND”), a cellular telephone, a mobile phone, a personal digital assistant (“PDA”), a watch, a camera, a computer, an in-vehicle or embedded navigation system, and/or other device that is configured with multiple sensor types (e.g., the sensors 117) that can be used for determined vehicular wait events according to the embodiments described herein. It is contemplated, that the UE 109 (e.g., cellular telephone or other wireless communication device) may be interfaced with an on-board navigation system of a vehicle 103 or physically connected to the vehicle 103 for serving as a navigation system. Also, the UEs 109 and/or vehicles 103 may be configured to access the communications network 115 by way of any known or still developing communication protocols. Via this communications network 115, the UEs 109, the vehicles 103, and/or the infrastructure elements 111 may transmit sensor data collected for mapping and/or predicting vehicular wait events.

In one embodiment, the sensors 117 of the UE 109 can include one or more physical sensors (e.g., accelerometer(s), gyroscope(s), magnetometer(s), barometer(s), LiDAR, camera, microphones, speakers, etc.), one or more virtual sensors (e.g., speed sensor(s), gravity sensor(s), rotation vector(s), heading/azimuth sensor(s), altimeter(s), activity sensor(s), steps counter(s), etc.), or a combination thereof. Some sensors convey similar information; however, redundancy can improve the robustness of the system and/or verify the accuracy of the system.

In one embodiment, the sensor data may be collected from vehicle sensors such as global positioning system (GPS) receiver(s), infrared sensors, LiDAR, radar, sonar, cameras (e.g., visible, night vision, etc.), light sensor(s), orientation sensor(s) augmented with height sensor(s) and acceleration sensor(s), tilt sensor(s) to detect the degree of incline or decline of the vehicle along a path of travel, moisture sensor(s), pressure sensor(s), audio sensor(s) (e.g., microphone), 3D camera(s), radar system(s), infrared camera(s), rear camera(s), ultrasound sensor(s), windshield wiper sensor(s), ignition sensor(s), brake pressure sensor(s), head/fog/hazard light sensor(s), ABS sensor(s), ultrasonic parking sensor(s), electronic stability control sensor(s), vehicle speed sensor(s), mass airflow sensor(s), engine speed sensor(s), oxygen sensor(s), spark knock sensor(s), coolant sensor(s), manifold absolute pressure (MAF) sensor(s), fuel temperature sensor(s), voltage sensor(s), camshaft position sensor(s), throttle position sensor(s), O2 monitor(s), etc. operating at various locations in the vehicle. In another embodiment, the sources of the sensor data may also include sensors configured to monitor passengers, such as O2 monitor(s), health sensor(s) (e.g. heart-rate monitor(s), blood pressure monitor(s), etc.), etc.

By way of example, the vehicle sensors may detect passenger status (e.g., the number of passengers actively seated), its own malfunctioning status, an accident, weather data, etc. Further, sensors about the perimeter of the vehicle may detect the relative distance of the vehicle from sidewalks, lane or roadways, the presence of other vehicles, people, trees, benches, water, potholes and any other objects, or a combination thereof. Still further, the vehicle sensors may provide in-vehicle navigation services, and location based services may be provided to user device(s) associated with user(s) of the vehicle 103.

The above-discussed embodiments can be applied to analyze sensor data from the vehicle/UE and/or nearby vehicles/UEs with the help to identify, locate and/or detect suspicious vehicle/UE presence events. In addition, the above-discussed embodiments can trigger alerts and/or actions to prevent and/or prohibit suspicious and/or illegal activities around roadways. Once an alert is triggered, officials can dispatch drones investigate in place of physical ground verification search and provide image(s) of the suspect or vehicle. The suspicious present event data can be tagged for training a machine learning model.

In one embodiment, the system 100 can collect the sensor data, contextual data, or a combination through one or more sensors such as the sensors 103, vehicle sensors connected to the system 100 via the communication network 115 (including camera sensors, light sensors, LiDAR sensors, radar, infrared sensors, thermal sensors, and the like), etc. to determine the type/kind of the vehicular wait events.

In one embodiment, the vehicles can be autonomous vehicles or highly assisted driving (HAD) vehicles that can sense their environments and navigate within a travel network without driver or occupant input. In one embodiment, the above-mentioned vehicle sensors acquire map data and/or sensor data when the vehicles travel on the street for detecting vehicular wait events, such as human/drug trafficking.

By way of example, the vehicle sensors may be any type of sensors that detect various context data. In certain embodiments, the vehicle sensors may include, for example, a global positioning sensor for gathering location data, a network detection sensor for detecting wireless signals or receivers for different short-range communications (e.g., Bluetooth, Wi-Fi, light fidelity (Li-Fi), near field communication (NFC) etc.), temporal information sensors, a camera/imaging sensor for gathering image data (e.g., for detecting objects proximate to the vehicles), an audio recorder for gathering audio data (e.g., detecting nearby humans or animals via acoustic signatures such as voices or animal noises), velocity sensors, and the like. In another embodiment, the vehicle sensors may include sensors (e.g., mounted along a perimeter of the vehicles) to detect the relative distance of the vehicles from any map objects/features, such as lanes or roadways, the presence of other vehicles, pedestrians, animals, traffic lights, road features (e.g., curves) and any other objects, or a combination thereof. In one scenario, the vehicle sensors may detect weather data, traffic information, or a combination thereof. In one example embodiment, the vehicles may include GPS receivers to obtain geographic coordinates from satellites 123 for determining current location and time. Further, the location can be determined by a triangulation system such as A-GPS, Cell of Origin, or other location extrapolation technologies when cellular or network signals are available. In another example embodiment, the one or more vehicle sensors may provide in-vehicle navigation services.

In one embodiment, the UEs 109 can be associated with any of the types of vehicles or a person or thing traveling within the geographic area. By way of example, the UEs 109 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UEs 109 can support any type of interface to the user (such as “wearable” circuitry, etc.). In one embodiment, the vehicles may have cellular or wireless fidelity (Wi-Fi) connection either through the inbuilt communication equipment or from the UEs 109 associated with the vehicles. Also, the UEs 109 may be configured to access the communication network 115 by way of any known or still developing communication protocols.

In one embodiment, the mapping platform 113 has connectivity over the communication network 115 to the services platform 123 that provides the services 125 (e.g., as in FIG. 1). In another embodiment, the services platform 123 and content providers 127 communicate directly (not shown in FIG. 1). By way of example, the services 125 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 127 may provide content or data (e.g., including geographic data, output data of the process 400, historical mobility data, etc.). The content provided may be any type of content, such as map content, output data, audio content, video content, image content, etc. In one embodiment, the content providers 127 may also store content associated with the geographic database 121, mapping platform 113, services platform 123, services 125, and/or vehicles traveling on a map link of interest. In another embodiment, the content providers 127 may manage access to a central repository of data, and offer a consistent, standard interface to data, such as a repository of the geographic database 121.

The communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 2/3/4/5/6G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mapping platform 113 may be a platform with multiple interconnected components. By way of example, the mapping platform 113 may include multiple servers, intelligent networking devices, computing devices, components, and corresponding software for determining upcoming vehicle events for one or more locations based, at least in part, on signage information. In addition, it is noted that the mapping platform 113 may be a separate entity of the system 100, a part of the services platform 123, the one or more services 125, or the content providers 127.

By way of example, the vehicles traveling on the map link of interest, the UEs 109, the mapping platform 113, the services platform 123, the services 125, and the content providers 127 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

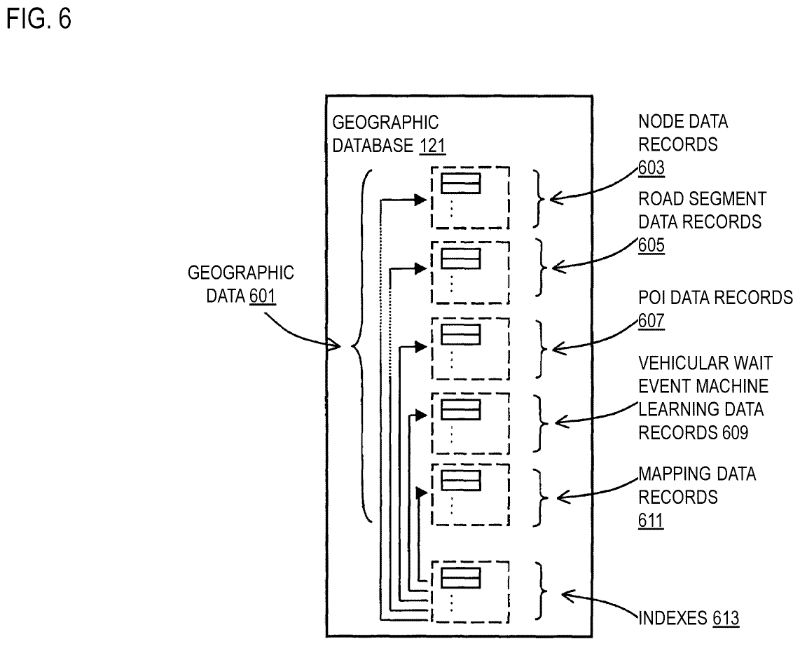

FIG. 6 is a diagram of a geographic database (such as the database 121), according to one embodiment. In one embodiment, the geographic database 121 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 121 include high resolution or high definition (HD) mapping data that provide centimeter-level or better accuracy of map features. For example, the geographic database 121 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 121.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 121 follows certain conventions. For example, links do not cross themselves and do not cross each other except at a node. Also, there are no duplicated shape points, nodes, or links. Two links that connect each other have a common node. In the geographic database 121, overlapping geographic features are represented by overlapping polygons. When polygons overlap, the boundary of one polygon crosses the boundary of the other polygon. In the geographic database 121, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 121 includes node data records 603, road segment or link data records 605, POI data records 607, vehicular wait event machine learning data records 609, mapping data records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 121. In one embodiment, the indexes 613 may be used to quickly locate data without having to search every row in the geographic database 121 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points (such as intersections) corresponding to the respective links or segments of the road segment data records 605. The road link data records 605 and the node data records 603 represent a road network, such as used by vehicles, cars, and/or other entities. Alternatively, the geographic database 121 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 121 can include data about the POIs and their respective locations in the POI data records 607. The geographic database 121 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city). In one embodiment, certain attributes, such as lane marking data records, mapping data records and/or other attributes can be features or layers associated with the link-node structure of the database.

In one embodiment, the geographic database 121 can also include vehicular wait event machine learning data records 609 for storing vehicular wait event data, vehicular wait event ground truth data, training data, prediction models, annotated observations, computed featured distributions, sampling probabilities, and/or any other data generated or used by the system 100 according to the various embodiments described herein. By way of example, the vehicular wait event machine learning data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles 103 and other end user devices with near real-time speed without overloading the available resources of the vehicles 103 and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 121 can be maintained by the content providers 127 in association with the services platform 123 (e.g., a map developer). The map developer can collect geographic data to generate and enhance the geographic database 121. There can be different ways used by the map developer to collect data. These ways can include obtaining data from other sources, such as municipalities or respective geographic authorities. In addition, the map developer can employ field personnel to travel by vehicle (e.g., vehicles 103 and/or UEs 109) along roads throughout the geographic region to observe features and/or record information about them, for example. Also, remote sensing, such as aerial or satellite photography, can be used.

The geographic database 121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 103 or a UE 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for building a machine learning model to map and predict vehicular wait events may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

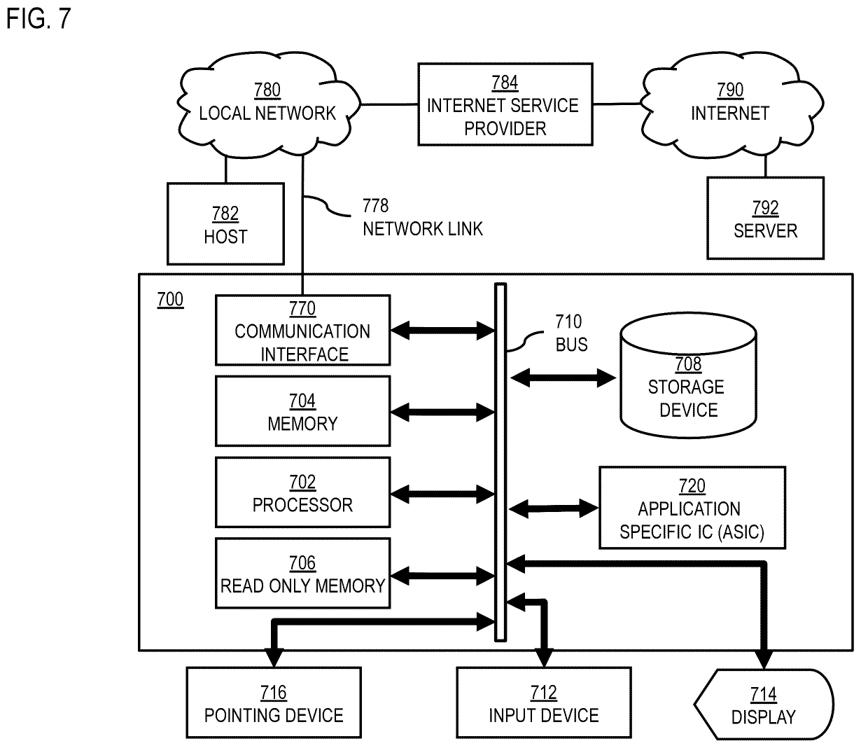

FIG. 7 illustrates a computer system 700 upon which an embodiment of the invention may be implemented. Computer system 700 is programmed (e.g., via computer program code or instructions) to build a machine learning model to map and predict vehicular wait events as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to building a machine learning model to map and predict vehicular wait events. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RANI) or other dynamic storage device, stores information including processor instructions for building a machine learning model to map and predict vehicular wait events. Dynamic memory allows information stored therein to be changed by the computer system 700. RANI allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for building a machine learning model to map and predict vehicular wait events, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 115 for building a machine learning model to map and predict vehicular wait events.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to build a machine learning model to map and predict vehicular wait events as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to build a machine learning model to map and predict vehicular wait events. The memory 805 also stores the data associated with or generated by the execution of the inventive steps.

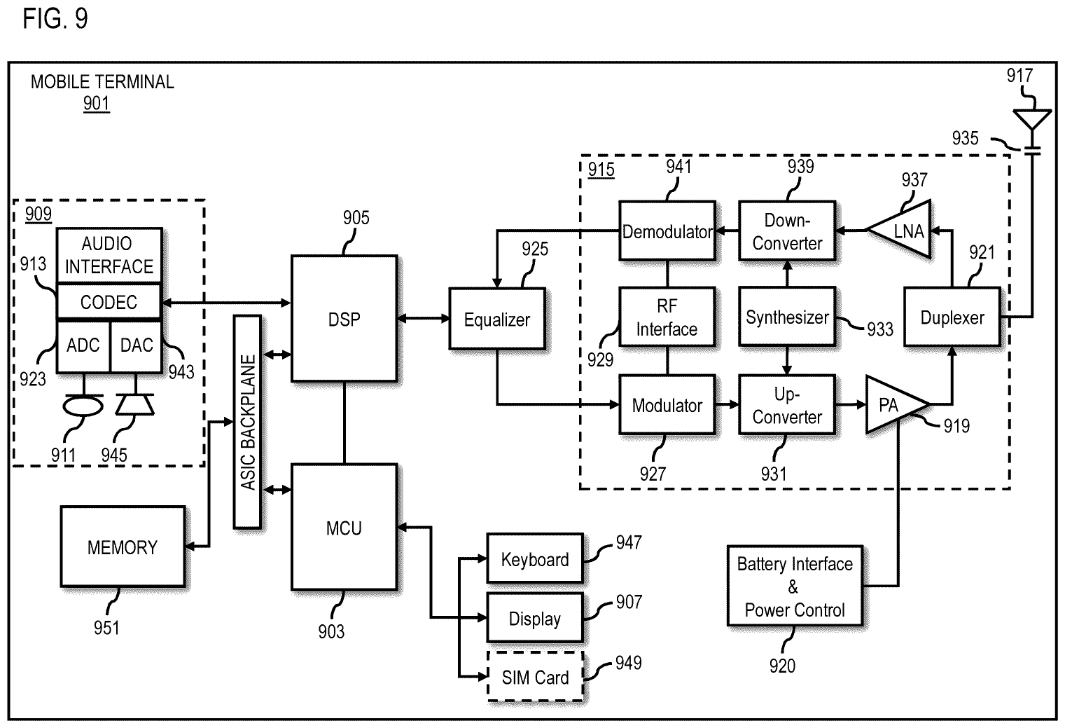

FIG. 9 is a diagram of exemplary components of a mobile terminal 901 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to build a machine learning model to map and predict vehicular wait events. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing a sensor observation to determine a wait event, wherein the wait event indicates that at least one person is in a wait state;
processing the sensor observation to determine one or more contextual features associated with a location of the wait event, a time of the wait event, the at least one person, or a combination thereof;
determining a ground truth of the wait state;
vectorizing the one or more contextual features and the ground truth into a training vector;
using the training vector to train a machine learning model to determine predicted waiting data based on one or more input vectors; and
providing the trained machine learning model as an output.

2. The method of claim 1, wherein the wait state includes the at least one person waiting inside a vehicle.

3. The method of claim 1, wherein the sensor observation comprises sensor data captured by one or more sensors of a device, a vehicle, an infrastructure element, or a combination thereof associated with or within a field of view of the at least one person.

4. The method of claim 1, further comprising:
map-matching location data of the sensor observation to a map link, an offset on the map link, or a combination thereof to determine the location of the wait event.

5. The method of claim 4, wherein the one or more contextual features further includes one or more attributes of the map link determined from a geographic database.

6. The method of claim 5, wherein the one or more attributes include a functional class, a speed limit, a presence of a road sign, a bi-directionality, a number of lanes, a speed category, a distance to a point of interest, a stopping or parking sign, a designated stopping or parking area, or a combination thereof associated with the map link.

7. The method of claim 1, wherein the predicted waiting data includes a predicted likelihood of at least one subsequent person waiting at a predicted location, a predicted time, or a combination thereof.

8. The method of claim 1, wherein the predicted waiting data includes a predicted reason for the at least one person being in the wait state.

9. The method of claim 8, wherein the predicted reason includes at least one of:
the at least one person waiting to pick another person;
the at least one person waiting for a point of interest to open; or
the at least one person sleeping in a vehicle.

10. The method of claim 1, further comprising:
using the trained machine learning model to determine the predicted waiting data; and
initiating at least one of:
generating navigation routing data, mapping data, or a combination thereof based on the predicted waiting data;
recommending at least one other person for meeting up, carpooling, or a combination thereof based on the predicted waiting data;
recommending at least one activity, at least one good, at least one service, marketing information, vehicle infotainment option, or a combination thereof based on the predicted waiting data;
delivering at least one good, at least one service, or a combination thereof to a location of a wait event based on the predicted waiting data;
presenting a warning message based on the predicted waiting data; or
predicting an impact on parking, traffic, or a combination thereof based on the predicted waiting data.

11. The method of claim 1, further comprising:
using the trained machine learning model to determine the predicted waiting data; and
using the predicted waiting data as an input to an autonomous vehicle control system for at least one of:
risk calculation;
routing;
adapting a safety distance at a specific location, a specific time, or a combination thereof;
selecting a travel lane; and
sharing a ride.

12. The method of claim 1, wherein the wait state indicates that the at least one person is remaining within a predetermined proximity of the location of the wait event until an occurrence of an anticipated event.

13. An apparatus for machine-learning of a vehicular wait event comprising:
at least one processor; and
at least one memory including computer program code for one or more programs,
the at least one memory and the computer program code configured to, with the at least one processor, cause the apparatus to perform at least the following,
process a sensor observation to determine a wait event, wherein the wait event indicates that at least one person is in a wait state;
process the sensor observation to determine one or more contextual features associated with a location of the wait event, a time of the wait event, the at least one person, or a combination thereof;
determine a ground truth of the wait state;
vectorize the one or more contextual features and the ground truth into a training vector;
use the training vector to train a machine learning model to determine predicted waiting data based on one or more input vectors; and
provide the trained machine learning model as an output.

14. The apparatus of claim 13, wherein the wait state includes the at least one person waiting inside a vehicle.

15. The apparatus of claim 13, wherein the apparatus is further caused to:
map-match location data of the sensor observation to a map link, an offset on the map link, or a combination thereof to determine the location of the wait event.

16. The apparatus of claim 15, wherein the one or more contextual features further includes one or more attributes of the map link determined from a geographic database.

17. A non-transitory computer-readable storage medium carrying one or more sequences of one or more instructions which, when executed by one or more processors, cause an apparatus to perform:
collecting sensor observation data of a vehicle;
determining one or more contextual features associated with the sensor observation data;
applying a waiting state model on the one or more contextual features to determine a waiting state associated with the vehicle; and
providing one or more services based on the waiting state.

18. The non-transitory computer-readable storage medium of claim 17, wherein the one or more contextual features are associated with a location of the waiting state, a time of the waiting state, at least one person waiting inside the vehicle, or a combination thereof.

19. The non-transitory computer-readable storage medium of claim 18, wherein the sensor observation data comprises sensor data captured by one or more sensors of a device, a vehicle, an infrastructure element, or a combination thereof associated with or within a field of view of the at least one person.

20. The non-transitory computer-readable storage medium of claim 17, wherein the one or more services include:
generating navigation routing data, mapping data, or a combination thereof based on the waiting state;
recommending at least one other person for meeting up, carpooling, or a combination thereof based on the waiting state;
recommending at least one activity, at least one good, at least one service, marketing information, vehicle infotainment option, or a combination thereof based on the waiting state;
delivering at least one good, at least one service, or a combination thereof to a location of a wait event based on the waiting state;
presenting a warning message based on the waiting state; or
predicting an impact on parking, traffic, or a combination thereof based on the waiting state.
